(19) United States
(12) Patent Application Publication
(10) Pub. No.: US 2018/0322038 A1
(43) Pub. Date: Nov. 8, 2018

(54) SEGMENTING USER POPULATION TO MANAGE DYNAMIC SOFTWARE QUALITY

(71) Applicant: Microsoft Technology Licensing, LLC, Redmond, WA (US)

(72) Inventors: Krishnan Thazhathekalam, Bellevue, WA (US); Khalid Mahmood, Redmond, WA (US); Sebastian Kohlmeier, Mountlake Terrace, WA (US); Anjali Muralidhar, Seattle, WA (US); Chaitanya Gogineni, Redmond, WA (US); Yun Lu, Redmond, WA (US); Jorge H. Banuelos, Kirkland, WA (US)

(21) Appl. No.: 15/586,957

(22) Filed: May 4, 2017

(51) Int. Cl. G06F 11/36; G06F 9/44

(52) U.S. Cl. CPC G06F 11/3696; G06F 11/3612; G06F 8/71

(57) ABSTRACT

In some embodiments, the disclosed subject matter involves a system and method relating to segmenting user population to test the quality of different software states. In at least one embodiment, the software states may be exposed dynamically to users who receive a software build, because features may be turned on/off via the server, at runtime. In an embodiment, if the server is unavailable, feature information may be retrieved from the local client storage. New features may be dynamically exposed to segments of a population to assist in verification and test of the new features. Other embodiments are described and claimed.

### TECHNICAL FIELD

An embodiment of the present subject matter relates generally to software builds, and more specifically, but without limitation, to dynamically exposing new features to segments of a population to assist in verification and test of the new features.

### BACKGROUND

Various mechanisms exist for testing software builds and new software versions. Configuration management systems are often used where a developer, or developer team, may check software modules in and out of the system. When a module or update is checked in, the module gets compiled and linked with other modules and features to build the final product.

As software systems become larger and more complex, and as marketing schemes with incremental level functionality become more popular, it becomes more and more difficult to test various versions of the software build. For instance, in a typical development environment, different teams work concurrently on different aspects of the entire system, including bug fixing and new features or enhancements.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating feature gates in software builds, according to an embodiment;

FIG. 2A illustrates various populations of users and how a population corresponds to a build version, according to an embodiment;

FIG. 2B illustrates the populations to show conceptual concentric rings, according to an embodiment;

FIG. 3 is a diagram illustrating a build system with selected flights or feature/configuration combinations, according to an embodiment;

FIG. 4 is a flow chart illustrating a method for building software applications with dynamic features that may be deployed to a segmented audience, according to an embodiment; and

FIG. 5 is a block diagram illustrating an example of a machine upon which one or more embodiments may be implemented.

### SUMMARY

Some organizations may deploy a system, or software build, with different feature sets or operational parameters to different audiences or user populations. As new features are developed, the new features need to be tested with each deployed version for each audience. However, a development team may be unaware of which features are being developed by other teams and how the features may interact for different populations. Embodiments as described herein use feature gates, or hooks, in software application code to enable an application program interface (API) to utilize classes and objects for access to configuration parameters that define the operational state of optional features in the software build. An audience of users may be further segmented into populations where one population receives a baseline software build and the other segment receives a non-baseline build with optional features enabled.

The subject matter disclosed herein allows a test team to “A/B test” features with various client builds. In an embodiment, at each test phase, two segments of the population may be selected to manage and test baseline builds and optional features with the baseline, where one segment receives the baseline and the other segment receives the non-baseline build. Thus, effects of rolling out new features may be isolated with respect to the baseline build. In existing systems, it is difficult to test the many dynamic features on top of a client build. Existing systems typically cannot ship software builds with different features to different populations due to the enormous effort required for quality testing. In the past, if a bug was found in a feature, it might force the developers to go back to the beginning of the test process and delay deployment for a significant amount of time, to back out the faulty feature.

An embodiment as disclosed herein is a system for generating a software build, comprising a processor executing build logic configured to generate a software build using build configuration information and feature configuration information, wherein the build configuration information identifies features to include in the software build, and the feature configuration information identifies one or more optional features dependent on feature profiles. A build configuration data store may be communicatively coupled to the processor, where the build configuration data store includes the build configuration information that identifies a baseline software build, and the feature configuration information that identities a plurality of optional features, and an operational state for each feature of the optional features. The system further includes baseline population data that identifies a first population of users to receive the baseline software build for use and non-baseline population data that identifies a second population of users to receive an expanded software build for use, wherein the expanded software build is to include the baseline software build and at least one additional optional feature, and wherein when the operational state of a feature is on, the feature is included in the expanded build.

Other embodiments may include a method, means for performing acts of the method, at least one machine-readable medium including instructions that, when performed by a machine cause the machine to perform acts of the method, or of an apparatus or system for segmenting a user audience into populations to manage and test software quality in a software build delivered to the user audience. Aspects described herein include installation of the software build on a client device and runtime management of the optional features on the client device, based on the population (e.g., baseline vs. non-baseline population).

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to segmenting user population to manage and test the quality of different software states. In at least one embodiment, the software states may be exposed dynamically to users who receive a software build, because features may be turned on/off via the server, at installation or runtime. In an embodiment, if the server is unavailable, feature information may be retrieved from the local client storage.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

The subject matter disclosed herein allows a test team to “A/B test” features with various client builds. In an embodiment, at a test phase, builds for two segments of the population may be managed and tested, where one segment utilizes the base build (e.g., baseline) and the other segment utilizes the base build plus one or more new features (e.g., non-baseline). Thus, effects of rolling out new features may be isolated with respect to the base build. In an embodiment, multiple or all test phases may utilize the population segmentation in testing. In existing systems, it is difficult to test the many dynamic features on top of a client build. Existing systems typically cannot ship software builds with different features to different populations due to the enormous effort required for quality testing. In the past, if a bug was found in a feature, it might force the developers to go back to the beginning of the test process and delay deployment for a significant amount of time, to back out the faulty feature.

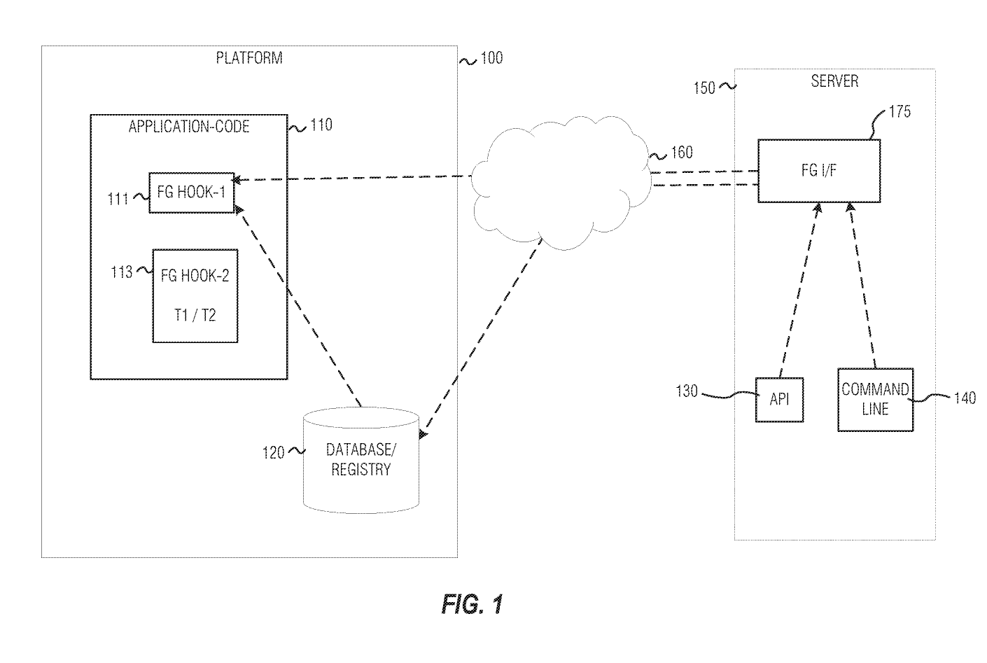

FIG. 1 is a diagram illustrating feature gates in software builds, according to an embodiment. A platform 100 is shown having an installed application 110. The code for application 110 may include feature gate code 111, 113. As described herein, application code may have software hooks in the code that define operation of a feature based on externally defined parameters. These software hooks may be referred to as “feature gates,” because a feature may be gated on or off, and/or specific parameters may be gated to A/B values. In an example, application code 110 may include feature gates 111 and 113. A feature gate is an internal on/off gate, or A/B gate. In some instances, the gate may turn the entire feature on or off. In another example, the gate may define a specific parameter for runtime, such as a timing of fast or slow for an operation (e.g., 5 ms vs. 100 ms), or something as simple as color for an alert (e.g., red vs. black). In an example, feature gate 113 may also be associated with two optional variables, or operational parameters. These operational parameters may be referred to as treatments. In this example, feature gate 113 may have two possible treatments, T1 and T2. For software that is heavy with user experience or user interfaces, successful testing may be dependent on user perception rather than just faults. For this type of system, there may be hundreds of dynamic features that may be on or off at varying percentages. This type of testing requires a more complex environment than previously available in traditional software development and test environments.

In an embodiment, source code 110 for a software build may include feature gates 111, 113 for specific features. The code may include a class used for the A/B testing. In an example, the A/B testing class is the AB_t class which represents an object having an associated value, where the value may differ depending on various client, or platform properties. The values may be determined by the Scope and feature settings for the user/client. In an example, features relate to A/B values and treatment codes. Scope may relate to things such as audience, language or other configuration settings. The context for features, A/B values, platform, etc. that define a specific build may be referred to as a flight. A Scope may be defined by code/binary in the software build. A flight, on the other hand, may be defined when a configuration is received from the Web portal, or configuration system. A vector of value-Scope pairs allows for defining values to be used for specific Scopes. A Scope value may be used in the absence of any dynamically configured value for this object. If the condition specified in a given Scope is satisfied, then the object holds the corresponding specified value.

In an embodiment, a Scope may be evaluated from left to right, and therefore the object may hold the value specified in the first Scope that satisfies the specific condition. Left to right refers to the vector of value-Scope pairs that allows for defining values to be used for specific Scopes. In absence of a dynamically configured value for a feature, the pairs may be evaluated in this vector from start to end (e.g., left to right), and the first pair for which the Scope evaluates to true, the corresponding value is assigned to the feature. A default value may be used when none of the Scopes satisfies the condition. Each AB_t object may include a feature name to be matched with flights received by the client. These flights may either send the entire object that the AB_t object holds, or the flight may send a reference to one of the predetermined values specified within AB_t. In an example, a flight, or selected combination of features, may be consistent throughout a session. In other words, features in the software may remain active/inactive until a new session for the software application is begun. In an embodiment, the AB_t class is effected using an application program interface (API).

Constructors may be used in the code 111, 113 to construct an object of type T in the AB_t class, where value of the object of type T may be configured dynamically. A default value may be used if there is no configured value. The constructor may include parameters such as feature-name, default-value, possible-values, Scope-values, etc. An operator T( ) may return a value used to get the value associated with the specified feature/setting. This value may vary depending on conditions within the current session. In an example, conditions may include feature override, registry override, server side configurations. Scope/value pairs, or others. Various types of overrides may be available based on where the override is set, e.g., client, server, audience-based, etc. In an example, a feature override may be based on an API, which may override a feature in a test framework. A registry override may apply when a developer sets an override in a registry key to override a feature value and test different behavior. A server side configuration may be the flight configuration system on the server side.

In an example, when various conditions are mutually exclusive, the precedence order of these conditions may be pre-defined. Other classes may be available to provide different audiences or feature sets based on other criteria. For instance, a Boolean class may be available to simplify the objects that do not require A/B testing.

In an embodiment, the new features are included with the compiled and linked software for the base build. However, the feature gates 111, 113 may be applied to make a feature either on or off or correspond to one parameter or another, as discussed above. In traditional software development, features that were not yet ready to be installed in the final deployment may have been included as a stub code. Various techniques for stubbing a function or module have been widely used by programmers for many years. However, code that has been stubbed out may not be tested until the full code is compiled and linked with the base build. Thus, testing these features manually by stubbing the code, and recompiling each time a stub is inserted or omitted, is time intensive and prone to delays in schedule when there are bugs found.

A software build may use defined parameters to dynamically configure the feature gates in several ways. In an embodiment, when the software build is installed on the platform 100 the feature gate parameters may be stored in a database or system registry 120 on the platform 100. In an embodiment, the platform may be a device having an architecture that does not use a system registry. In this example, the database may emulate a system registry, or retrieve feature and configuration for a database communicatively coupled to the platform. The database may be directly connected, or accessed over a network. The software may determine whether the features are exposed (e.g., enabled) at runtime, by retrieving the parameters from the database/registry 120. In an embodiment, the features may remain static during testing for a specific audience, as defined by parameters stored in an experiment and configuration system, as described below. Each feature may have a default value in code. Feature gates and AB_t objects may have a default value in code/Source Depot in case access to a Web portal (e.g., network accessed database) is unavailable. Overrides may be present in the registry, or local database 120, so that a value may be returned when called. The values retrieved from network database and registry may take precedence over the default values stored in code.

In an embodiment, the parameters may be sent to the platform 100 using an application program interface (API) 130 or a command line interface 140. In an embodiment, the command line interface 140 or API 130 may provide feature gate overrides, or flight information to a feature gate interface 175. The feature gate interface 175 may reside on server 150 and take the command line or API models and help build the database/registry 120. The feature gate interface 175 may also act as a Web portal for API calls in the application code 110, and accessed over network 160, to provide configuration and flight information during runtime. The platform 100 may communicate with server 150 via a local or public network 160. In an embodiment, the configuration parameters may be stored in database/registry 120 during installation of the application on a test machine. In an embodiment, feature configuration parameters may be stored in the database/registry 120 during installation, but may be dynamically overridden during runtime based on a platform, user, audience, or channel designation to be used in the feature gate 111, 113. In an embodiment, feature gate parameters may be retrieved from the server 150 (e.g., from the feature gate interface 175) during launch, runtime or installation. If the server 150 is unavailable, default parameters store in the database/registry 120 may be used.

The concept of folding in one or more new or updated features to a stable base software build may be referred to herein as “feature rollout.” Various feature rollouts may be dynamically disabled to fix an issue (e.g., bug or poor user experience) found in testing and may result in little or no delay in the release of the client build. An embodiment, as described herein, provides a process that allows the development and testing teams to assess if an issue was due to the base build (which may require a code fix and a new build, including a new test cycle), or due to one or more feature rollouts (which may be quickly mitigated by turning them off). In an embodiment, a process is used to segment an audience of users into a user population that receives the base build only, and at least one other user population that would receive the base build including one or more feature rollouts. In an example users with an audience A may be segmented into two populations, one to receive the baseline build and one to receive a build that includes optional features. By comparing the two segments or populations, the effects of feature rollouts in the non-baseline build may be isolated and decoupled from the base build release, when necessary.

In an embodiment, source code 110 for the software build may be implemented in a specific language such as C# for various platforms and operating systems. Feature gate APIs 130 may also be implemented in C# for ease of interoperability. For instance, source code may be the same for a platform 100 running a Microsoft® Windows® operating system (OS), a mobile device running Android™ OS, or a device running Apple® iOS® or MacOS™ OS. In an example, for instance, the Android™ OS application user interface (UI) components make use of native platform capabilities and thus, they may be implemented in Java® code. A Java® wrapper layer may be used for an implementation of Feature Gates 111, 113 for Android™ devices. In an embodiment, the Java® wrapper layer internally may call into C# Feature Gate APIs 130 using Java-Native Interface (JNI).

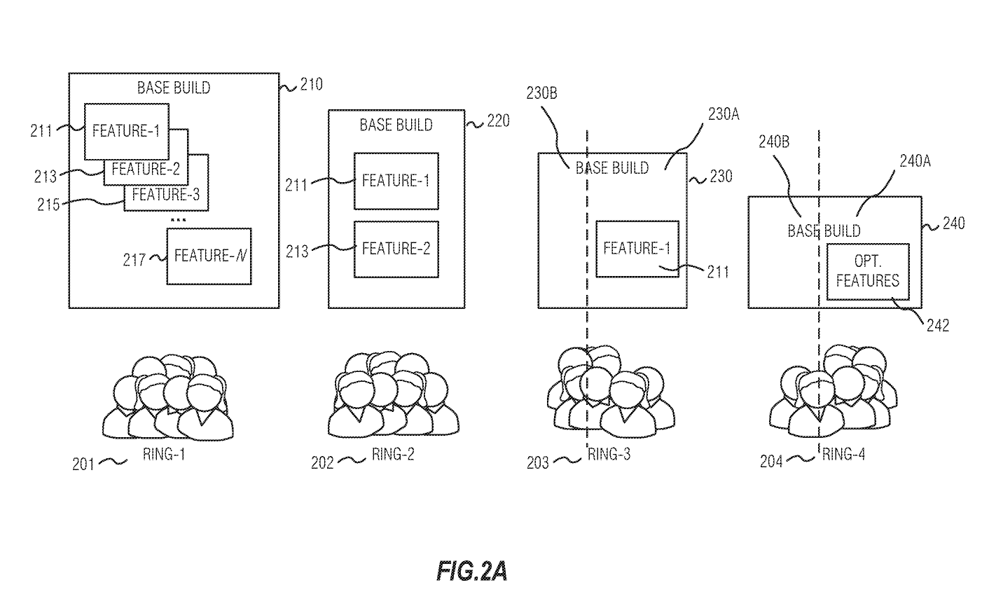

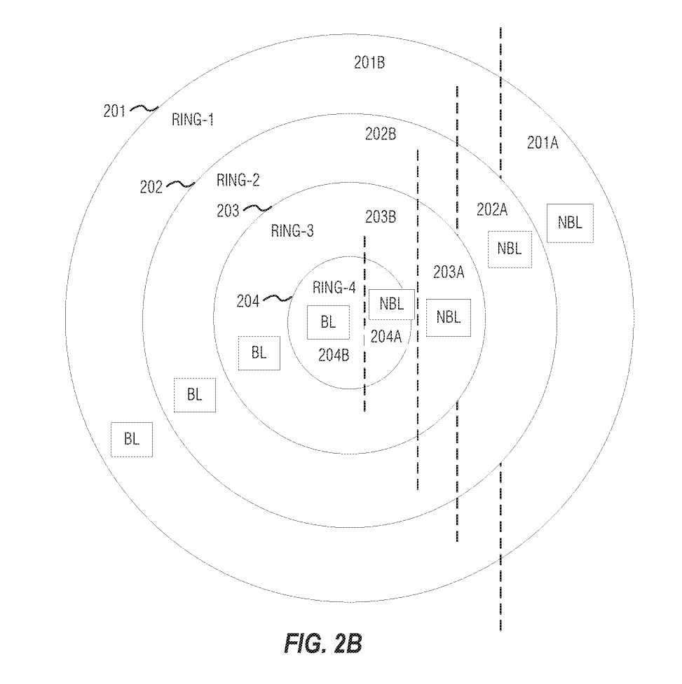

In an embodiment, a software system may be deployed to different audiences based on the sophistication or familiarity that the users of an audience may have with this software system. An audience may be referred to as a “ring.” FIG. 2A illustrates various audiences of users and how an audience may correspond to a build version, according to an embodiment. In an example, a system may be deployed to four audiences, or rings, ring-1 201, ring-2 202, ring-3 203, and ring-4 204. In the illustrated example, ring-4 204 represents the population of end-users that receive the base build that has been fully tested and is operationally stable 240. Ring-1 201 represents a user population of the developers who may be creating any of features 1-N (211, 213, 215, 217) and may need to test their team's feature with the base build and with other teams' new features 210. Depending on the size of the software system and how many different sets of users are available to test various features, an enterprise may have more than, or fewer than, the four rings, as illustrated. In this example, ring-2 202 represents an audience that is to receive the base build plus features 1 and 2 (211, 213) as build 220. This ring may correspond to a larger group that is internal to the development team or enterprise, so that discovered bugs have less of a risk associated with end-users. In some environments, a subset of the end-users may choose to opt in to receive advance deployment of new features, and assume the risk that there are bugs. In this example, ring-3 203 represents an audience of end users that have opted in to advanced deployment. The build for ring-3 203 may include the base build and feature 1 (211) as build 230.

When a feature fails in a ring, it may be removed from all rings for repair and update and then begin testing in ring-1 again. In an example, it is possible that a feature passed a ring because it was underutilized and not fully tested. In order to assist in testing features, and combinations of features for an audience the audience may be segmented into two populations, so that a selected percentage of users in the audience receive a baseline version, e.g., a build that has already passed for that audience ring, and some users in the audience may receive the baseline plus the optional features being tested at that ring level. In the example shown in FIG. 2A, ring-3 audience 203 may be segmented into two populations 230A and 230B, based on pre-defined percentages. In this example, users in population 230A may receive the base build associated with audience 203, as well as feature-1. Users in population 230B may receive the base build for audience 203 and not have access or visibility to feature-1. In an embodiment, the build for user population 230B may include the code for feature-1, but it will be gated off, as described below, so that feature-1 will be hidden to users in population 230B. Similarly, the ring-4 audience may also be segmented into two populations 240A and 240B. The users in population 24013 may receive the baseline production build, where the users in population 240B may also have some optional features 242 exposed. An experimentation and test team may analyze feedback and bug/crash reports from the users in various populations to understand whether features promoted to a segmented ring are causing an issue, or whether the issue is actually in the baseline for that ring/audience, that was previously believed to be stable.

FIG. 29 illustrates the ring populations to show conceptual concentric rings, according to an embodiment. FIG. 2B illustrates the ring populations as shown in FIG. 2A (201-204). It may be seen that ring-4 204 is the smallest concentric ring. Ring-4 may include the baseline build that is to be deployed to end-users, and excludes features that have not been fully tested and integrated in previous rings. The outermost ring, ring-1 201 may include many optional features under test and experimentation. As the ring/audience gets smaller and closer to the center, the code and features are expected to be more stable and tested. Audiences may be thought of as being at various stages of the development lifecycle, with the innermost ring being the final and most stable stage.

In an embodiment, feature rollouts at every stage of the development lifecycle will typically have a lower probability of exhibiting fatal errors because the features may be validated at each ring in both an on and off state. In an example, a feature may not be promoted to a next innermost ring until it has been validated in an outer ring. Integration and development may be enhanced because teams have the ability to test with features that have not yet been completely rolled out. In a traditional development and test environment, each team would include their feature in the base build and then test to see if that build is stable. However when there are dozens of teams working on various features, there is no way in the traditional model to test a feature against a different feature that has not vet been integrated into the build. In an embodiment, a development team is able to test their new feature as if they were operating at a different ring. If the development team working on feature 1 determines that the feature has been tested enough with the various other features in ring-1 201 and is fully stable, feature 1 may be added to the next ring, ring-2 202, then ring-3 203, and so on. Ultimately ring-4 204, referred to as the audience for a stable base build, includes the previous release version plus all fully tested stable features that have been promoted through the rings.

It should be understood that a baseline build for each ring, or audience receiving a production build, may expose the same fully tested features. Testing new features with the baseline, for a specific audience, may include feature overrides that expose or hide (disable) selected features for the audience, or ring. In an embodiment, the same baseline build may be deployed to audiences at each ring. The difference is whether selected features are enabled (exposed) or disabled for that particular audience and channel. As discussed herein, a baseline build for an audience refers to the baseline build with specific features gated on or off, according to their prior testing. A non-baseline build includes additional features gated on or off that need further testing before being promoted to another ring. It should be understood, that in an embodiment, the baseline and non-baseline builds may include identical code. The difference in the baseline and non-baseline builds may occur at runtime when the features are dynamically configured to be enabled or disabled.

Once features have been promoted to an inner ring/audience, it may become more difficult to ascertain whether bugs and anomalies are the cause of the added feature or audience baseline. In an embodiment, each audience (ring) may be segmented into two populations where one segment receives the baseline build corresponding to the audience, and the other segment receives the baseline plus optional features exposed for testing in the audience. In the example shown, audiences ring-1 201, ring-2 202, ring-3 203, and ring-4 204 are segregated into baseline (BL) populations 2013, 2023, 2033, 2043; and non-baseline (NBL) populations 201A, 202A, 203A, 204A, respectively. By comparing user reports from each population segment, it may be easier to identify whether the errors are due to problems with baseline or non-baseline builds.

In real world software development and deployment, there may be several channels of deployment to various populations. For instance, an end user in the population corresponding to ring-4 204 may be scheduled to receive the production base build, e.g., most stable version. Some end-users may prefer a different update schedule. For instance, one channel of users may prefer a monthly update with bug fixes and new features. Another channel of end-users may prefer the same build but only every six months, for more stability. Other channels may be related to validating feature readiness. For instance the term “fork” as used herein represents the channel that includes feature rollouts that are ready to go all the way to a production system, or end-users. Before a feature is ready to be in the fork release, it may conceptually correspond to a channel referred to DEV, for a development channel. In an embodiment, audience populations may be segmented for only the production channel, or a limited number of channels.

As discussed above, a developer may wish to include many new features in a fork release, where the features may be developed by disparate teams. Managing and testing a feature with every permutation of other features is neither desirable, nor feasible. However, segmenting the population of users at each ring into a baseline population and a non-baseline population allows the new features to be tested against a more controlled build (e.g., the baseline build). In an embodiment, the population may be segmented at a 60-40 ratio for non-baseline to baseline build testing. In other words, for a selected audience, 60% of the users in the audience, or ring, will receive the non-baseline build (e.g., baseline plus new features) and 40% of the audience will receive the baseline build. As features migrate to the production build by passing test at each ring, they may be integrated into the base build. Ultimately, the production build, or final baseline build (e.g., production fork) which includes the baseline and tested and stable new features, may be delivered at 100% audience, without segmentation. For the example, as shown in FIGS. 2A and 2B, this production population, or audience, equates to the ring-4 204 audience. It will be understood that these percentages may vary in implementations. The 60-40 ratio, or alternative ratio for population segments, should be consistent in each fork testing, regardless of how the data is sliced (e.g., application vs. build). There may be different baseline/non-baseline distributions on different platforms and audiences, but each platform/audience distribution ratio should be honored consistently in every fork.

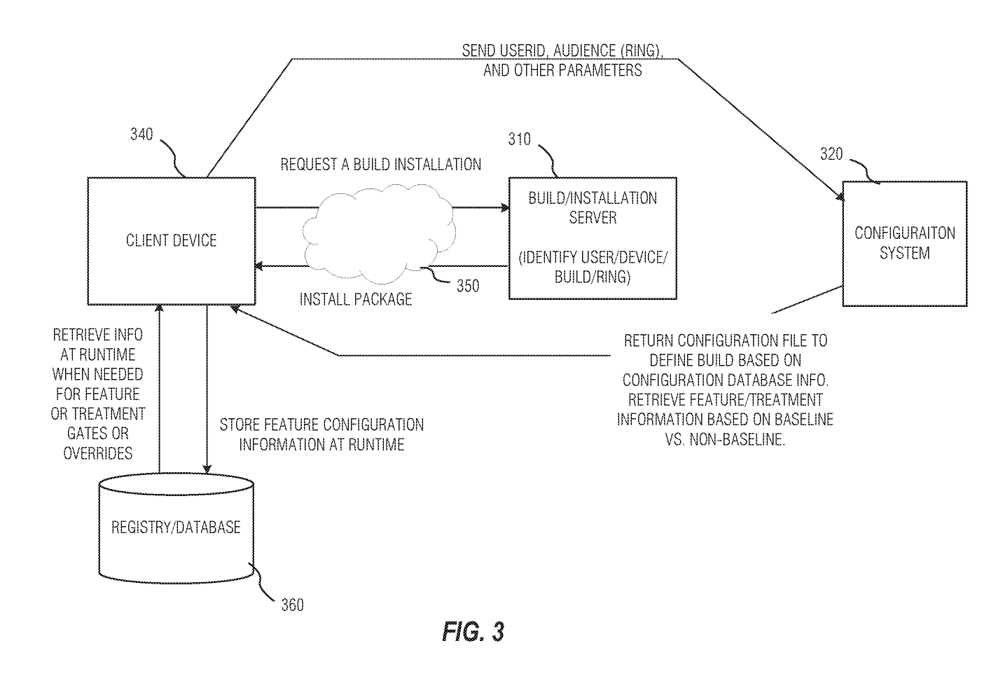

FIG. 3 is a diagram illustrating a build system with selected flights or feature/configuration combinations, according to an embodiment. In an embodiment, XML or other data files containing flight information (e.g., feature combination, platform, audience information, etc.) may be applied to different builds or audiences. In an example, the base build may be re-run on a daily basis to include fully tested features or to exclude features that have failed testing. As discussed above, software builds for applications and product packages may vary based on audience and channel. In some scenarios, it may be advantageous to enable a baseline (also referred to as baseline build) for a percentage of users in an audience/channel, and enable the baseline plus one or more optional features (also referred to as non-baseline build) for the remaining percentage of users in the audience/channel. In an embodiment, the non-baseline build may have additional features exposed and/or hidden.

In an embodiment, a user on a client device 340 requests a build installation, either as a new application, repair or update of a previously installed application. The request may be sent via a network 350, such as the public. Internet, but may also be via an intranet, local area network (LAN), etc. A build/installation server 310 may service the request. The server 310 may identify both the client device 340, as well as, user (not shown) to determine which build should be installed on the client device 340. In an example, a user U may access or log in to the server 310 and may be identified by a unique user identification (e.g., user id) and device identifier (e.g., device id). In some cases, more than one user may access the application on device 340. Server 310 may access a database to match the user/device with an appropriate audience/channel.

In an embodiment, the same build is installed on a client device regardless of whether the user is to fall within the baseline population or non-baseline population. The baseline/non-baseline designation may be conducted at runtime. Once the product or application build has been installed on the client device 340, the user may launch the application/product. Upon launch, user id, audience/channel and device/architecture information may be sent to a configuration system 320 to determine whether the build should operate as a baseline build or a non-baseline build. In an embodiment, a hash may be derived from the user id and mapped to either the baseline or non-baseline build, based on a pre-defined ratio. A different percentage may be used for different applications, or development phases, as appropriate.

The configuration system 320 may make the baseline/non-baseline determination and return a configuration file to the client device 340. The configuration file may include feature/treatment information that identifies the default baseline configuration or a configuration that either exposes, hides or configures optional features/treatments. In an embodiment, a feature may have a corresponding feature profile. A feature profile may identify for which audiences the feature is included, either as baseline or optional. The feature profile may also identify varying treatments and parameters for the feature, based on audience, platform, architecture, language, or other filters. The feature profiles may be used to generate the configuration file to be sent to the client device to control runtime features. Feature profiles may be used to generate configuration profiles, or configuration files.

In an example, the appropriate configuration profile may be sent to client device 340, for instance, based on user id, audience, platform and architecture and baseline/non-baseline determination. In an embodiment, the configuration system 320 may return an XML or other data file or send a JSON (JavaScript Object Notation) formatted file to the client device 340. JSON data may be used for different sections of the page. The server may execute an additional process or module/logic to translate JSON into HTML or XML. JSON is a lightweight data-interchange format, where formatted text is both easy for humans to read and write, and for machines to parse and generate. Various formats may be used for the configuration file. The configuration file may identify optional features and/or treatments as appropriate.

The launch process on the client device 340 may include instructions to store the configuration information in a local database 360, such as the system registry. Feature and treatment information may be specific to the device 340 or be specific for a user, or user/device pair. In an embodiment, when a user executes the application, information from the database 360 may be retrieved based on the build package, and manages whether the optional features/treatments are available during runtime. In an embodiment, an application program interface (API) is used in the application code, such as for a feature gate, to manage whether a feature is exposed (enabled) or dark (disabled), and to define values for non-Boolean features and treatments. In an example, a feature gate may retrieve a dynamic value for a feature/treatment from the database 360, based on user and device identifiers, where the user identifier may map to a specific audience.

In an embodiment, once the baseline/non-baseline designation is made during launching of the product or application, the feature and treatment configuration is set and stored in a local database 360 for the client device 340. This configuration may be static for the client, or differ for different users on the client 340. The features and treatments available at runtime may be controlled by the configuration profiles stored in registry/database 360 and may differ for baseline and non-baseline designation, for the same installed product.

In an embodiment, the configuration system 320 may not be available at the time the user launches the application. In this case, a baseline version may be applied, by default, until the configuration system becomes available. In another embodiment, the client device 340 may perform the user id hash described above and make an independent determination of whether the build should operate as baseline or non-baseline. In embodiment, this designation may remain static when the configuration system 320 becomes available. In another embodiment, the configuration system 320 may override a client designation of baseline/non-baseline. In sonic embodiments, a user may not be downgraded from non-baseline to baseline build, because this would cause previously exposed optional features to disappear for a subsequent session.

In an embodiment, bugs or feature rollout may result in changes to the baseline. However, in an embodiment, a user's baseline/non-baseline designation remains static. For instance, if a bug has been reported in feature A which is included (exposed) in the baseline for the user's audience, the developer may release a new baseline with feature A hidden (disabled). It should be understood that when feature A is disabled for the baseline build, it may be disabled for the non-baseline build, also. In an embodiment, it may not be necessary to force the user to reinstall the product. Instead, when the user launches the product/application a new configuration profile may be retrieved from configuration system 320 which causes the information in registry/database 360 to be updated with the new feature gate information. In another case, a feature may be removed (disabled) from the baseline build but remain enabled in the non-baseline build. Features may be enabled or disabled dynamically using an API to retrieve configuration information from the database 360 at runtime. This may be advantageous for continued testing and diagnosis of anomalies in the code.

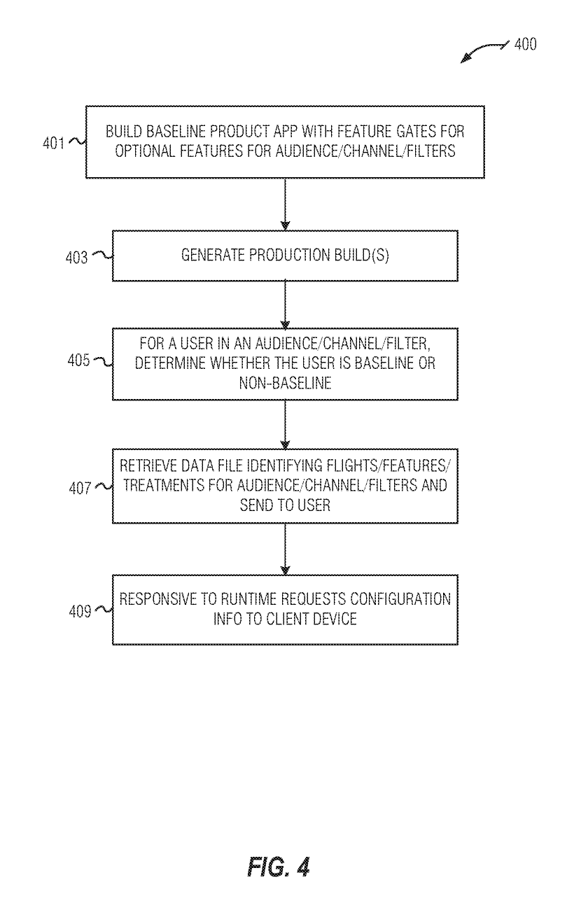

FIG. 4 is a flow chart illustrating a method 400 for building software applications with dynamic features that may be deployed to a segmented audience, according to an embodiment. At a specific ring or audience, a baseline product application may be built with static and dynamic optional features, in block 401. For instance, features that are to be gated are coded with the software hook, or API calls (e.g., feature gates), as discussed above. The developers may then identify state information for a feature, with respect to audience, device, and other filters and record the information in a database coupled to the configuration system (e.g., FIG. 3. 320). The state information may include information for each optional feature as to whether the feature should be exposed in a build for a specific audience/channel, and default values for various parameters associated with the feature. Each feature may have an associated feature profile that identifies whether the feature is to be exposed or dark, or have varying treatments based on a number of filters and Scopes. For instance, a feature may have default operational values based on build identifier, audience, channel, device, architecture, language, etc. A build profile may be generated that identifies the set of static features for the baseline build and optional features associated with various audiences.

The configuration system may use the build profiles and then generate a build for a selected audience, in block 403. When a client device launches the build, a user id and other identifiers may be sent to the configuration system. The configuration system may then hash the user id, or use some other method, to determine whether the user should be in the baseline or non-baseline population, in block 403. Once the population segment is determined, configuration profiles of files that identify optional features and treatments based on selected filters may be generated. A feature may have an associated percent or ratio value to be used in the calculation for baseline/non-baseline exposure.

Once the configuration profile information is identified for the build/audience, and is sent to the client device, in block 407, it may be stored in a local registry in a format accessible by the feature gate API calls. The configuration information may be tied to the determined population segment. At runtime, the dynamic feature gates may retrieve the profile information from either the local registry/database or from the configuration system, in block 409, to dynamically determine which features and treatments should be operational, based on the build and the user's population segment (e.g. baseline vs. non-baseline).

The configuration information may be used to define specific configuration settings for the baseline and non-baseline builds, based on audience, channel, and other filters. The configuration system may also include mapping information for users/devices to a population segment (e.g., baseline vs. non-baseline). Segmentation of users/devices may depend simply on a hash of the user id, or include more hash or mapping information based on a number of other demographics which may include the user identifier such as a login id, device identifier, platform type, platform, architecture, geographic location, opt in or out information, service level information, etc. A feature filter may be identified as 100% for a static feature, n % for non-baseline feature, or 0% for features that should be disabled for all audiences. The population segment may be determined based on the identifying information and pre-defined criteria, such as baseline vs. non-baseline ratios, and audience/channel information. Various algorithms may be used to ensure that the ratio of baseline users to non-baseline remains substantially as pre-defined. The mapping and/or segment identification 405 may be conducted at any time in the process, or on-demand at installation or runtime.

Feedback from the two populations in an audience/channel may be analyzed by an experimentation and test team to determine whether an optional, or non-baseline feature is ready to be promoted to a next inner ring (audience). For instance, feedback, as an aggregation of system level health metrics such as crashes, may be collected by default, and forwarded to the experimentation and test team. If the non-baseline build shows sufficient stability for feature A, for instance, feature A may be promoted to ring-2. When a feature is promoted to a next ring for testing, it is typically made part of the baseline in the current ring, e.g., statically enabled. In this example, enabling feature A for promotion may add feature A to the current baseline, and may require an update to the feature information in the configuration database.

In an example, it may be seen that both the baseline and non-baseline builds may present the same errors. In this case, the error may exist in a feature that was previously promoted. The experimentation and test team may need to do further analysis to identify the feature causing the problem. Once identified, the feature may be disabled, or made dark, by modifying the configuration and dependencies in the configuration database, and may not be included in the next build for any audience, channel or population until fixed (not shown).

In an embodiment, the same build executable is provided to a user during installation regardless of to which population the user belongs. All static and dynamic optional features may exist in the installed product. The configuration information provided, at launch, may identify percentages, population mapping information, and feature/treatment parameters and values, for the build, audience, channel, platform, architecture, etc. The appropriate configuration information may be stored locally on the client in the database or registry so that the build may be dynamically configured at launch or runtime, as appropriate. Thus, in an embodiment, only one actual executable is deployed for a specified audience/channel/filter/platform and may be managed more easily than if two or more versions of software were deployed (e.g., one for each population segment).

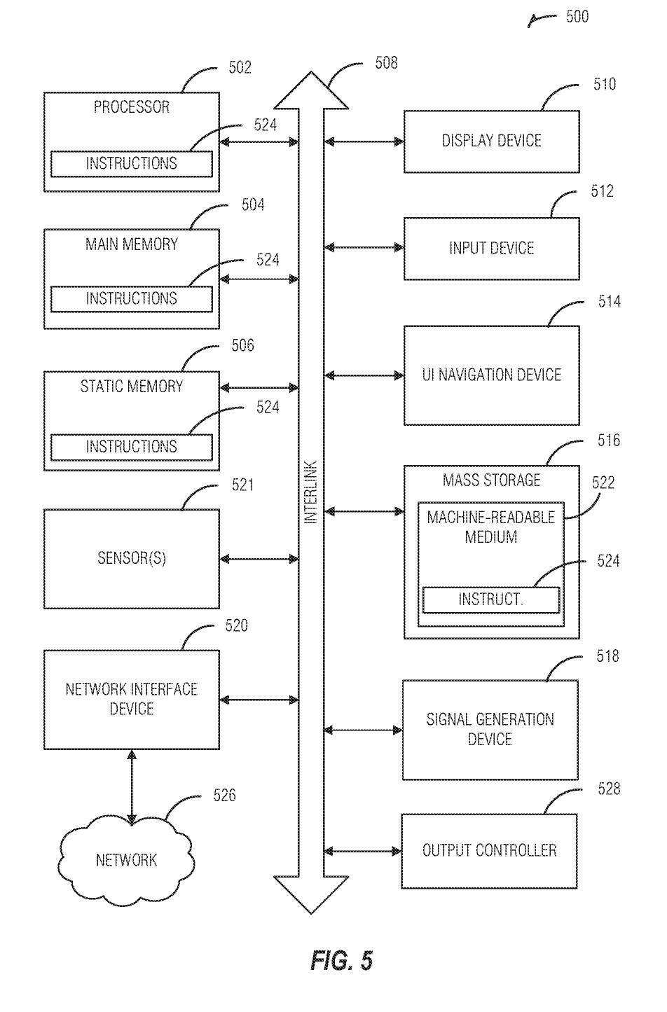

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial(e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to perform acts of the method, or of an apparatus or system for segmenting a user audience into populations to manage and test software quality in a software build delivered to the audience, according to embodiments and examples described herein.

Example 1 is a system for building a software build, comprising: a processor executing build logic configured to generate a software build using build configuration information and feature configuration information, wherein the build configuration information identifies features to include in the software build, and the feature configuration information identifies an optional feature dependent on a feature profile; a build configuration data store communicatively coupled to the processor, the build configuration data store including the build configuration information that identifies a baseline software build, and the feature configuration information that identifies a plurality of optional features, and an operational state for each feature of the optional features; baseline population data that identifies a first population of users to receive the baseline software build for use; and non-baseline population data that identifies a second population of users to receive an expanded software build for use, wherein the expanded software build is to include the baseline software build and enable at least one additional optional feature, wherein when the operational state of a feature is on, the feature is enabled in the expanded build.

In Example 2, the subject matter of Example 1 optionally includes wherein the build logic is configured to send configuration information for the software build to a client device over a network, the configuration information to identify a baseline or a non-baseline configuration for the software build.

In Example 3, the subject matter of Example 2 optionally includes wherein the configuration information is to be stored in a database local to the client device for access during runtime of the software build, the configuration information to enable dynamic features in the software build during runtime, the dynamic features based at least on whether an identified population is the first population or second population.

In Example 4, the subject matter of Example 3 optionally includes wherein the database local to the client device comprises a system registry.

In Example 5, the subject matter of any one or more of Examples 1-4 optionally include wherein the database local to the client device comprises a system registry emulation data store when the client device that does not utilize a registry architecture.

In Example 6, the subject matter of any one or more of Examples 1-5 optionally include wherein the expanded software build is to include the baseline software build and disable at least one feature identified in the build configuration information, wherein when the operational state of a feature is off, the feature is disabled in the expanded build.

Example 7 is a machine implemented method for dynamically enabling features to a selected population during runtime, comprising: responsive to identification of a user and device at runtime of an application, determining whether an installation of the application is a baseline population or a non-baseline population, based at least on the user and device identification; retrieving configuration information from a data store based on the determining; enabling a baseline of features for the application when the population is the baseline population; and enabling a baseline of features and a set of selected optional features for the application when the population is the non-baseline population, wherein the selected optional features are identified in the configuration information.

In Example 8, the subject matter of Example 7 optionally includes disabling at least one feature identified in the configuration information, wherein when an operational state of the at least one feature is off, then the at least one feature is disabled during runtime.

In Example 9, the subject matter of any one or more of Examples 7-8 optionally include wherein the identification of a user and device is performed either on the device or on a server communicatively coupled to the device.

In Example 10, the subject matter of any one or more of Examples 7-9 optionally include wherein the data store comprises a system registry emulation data store when the device does not utilize a registry architecture.

In Example 11, the subject matter of any one or more of Examples 7-10 optionally include wherein determining whether the installation is a baseline population or a non-baseline population, further comprises: applying a ratio for base population and non-baseline population to an audience; and associating at least one of the user or device with the baseline population or the non-baseline population, based in part on the ratio.

In Example 12, the subject matter of any one or more of Examples 7-11 optionally include wherein enabling the set of selected optional features includes: retrieving feature information from the configuration information using an application program interface within the application to enable each of the optional features in the set of selected optional features, at runtime.

In Example 13, the subject matter of any one or more of Examples 7-12 optionally include providing feedback on usage of the application, wherein the feedback identifies the determined population, and a qualitative measure associated with the application.

Example 14 is a machine readable storage medium having instructions stored thereon, the instructions when executed on a machine cause the machine to: identify a user and device at runtime of an application; determine whether an installation of the application is a baseline population or a non-baseline population, based at least on the user and device; retrieve configuration information from a data store based on the determining; and enable a baseline of features for the application when the population is the baseline population; and enable a baseline of features and a set of selected optional features for the application when the population is the non-baseline population, wherein the selected optional features are identified in the configuration information.

In Example 15, the subject matter of Example 14 optionally includes instructions to: disable at least one feature identified in the configuration information, wherein when an operational state of the at least one feature is off, then the at least one feature is disabled during runtime.

In Example 16, the subject matter of any one or more of Examples 14-15 optionally include wherein the data store comprises a system registry on the device or a system registry emulation data store when the device does not utilize a registry architecture.

In Example 17, the subject matter of any one or more of Examples 14-16 optionally include instructions to: receive the configuration information over a network from a configuration system; and store the configuration information in the data store in a format accessible by an application program interface call in code in the application, the code associated with an optional feature, wherein the configuration information identifies an operational state for the optional feature.

In Example 18, the subject matter of any one or more of Examples 14-17 optionally include wherein determining whether the installation is a baseline population or a non-baseline population, further comprises instructions to: apply a ratio for base population and non-baseline population to an audience; and associate at least one of the user or device with the baseline population or the non-baseline population, based in part on the ratio.

In Example 19, the subject matter of any one or more of Examples 14-18 optionally include wherein enabling the set of selected optional features includes instructions to: retrieve feature information from the configuration information using an application program interface within the application to enable each of the optional features in the set of selected optional features, at runtime.

In Example 20, the subject matter of any one or more of Examples 14-19 optionally include instructions to: provide feedback on usage of the application, wherein the feedback identifies the determined population, and a qualitative measure associated with the application.

Example 21 is a system configured to perform operations of any one or more of Examples 1-20.

Example 22 is a method for performing operations of any one or more of Examples 1-20.

Example 23 is a machine readable medium including instructions that, when executed by a machine cause the machine to perform the operations of any one or more of Examples 1-20.

Example 24 is a system comprising means for performing the operations of any one or more of Examples 1-20.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A system for building a software build, comprising:
a processor executing build logic configured to generate a software build using build configuration information and feature configuration information, wherein the build configuration information identifies features to include in the software build, and the feature configuration information identifies an optional feature dependent on a feature profile;
a build configuration data store communicatively coupled to the processor, the build configuration data store including the build configuration information that identifies a baseline software build, and the feature configuration information that identifies a plurality of optional features, and an operational state for each feature of the optional features;
baseline population data that identifies a first population of users to receive the baseline software build for use; and
non-baseline population data that identifies a second population of users to receive an expanded software build for use, wherein the expanded software build is to include the baseline software build and enable at least one additional optional feature, wherein when the operational state of a feature is on, the feature is enabled in the expanded build.

2. The system as recited in claim 1, wherein the build logic is configured to send configuration information for the software build to a client device over a network, the configuration information to identify a baseline or a non-baseline configuration for the software build.

3. The system as recited in claim 2, wherein the configuration information is to be stored in a database local to the client device for access during runtime of the software build, the configuration information to enable dynamic features in the software build during runtime, the dynamic features based at least on whether an identified population is the first population or second population.

4. The system as recited in claim 3, wherein the database local to the client device comprises a system registry.

5. The system as recited in claim 1, wherein the database local to the client device comprises a system registry emulation data store when the client device that does not utilize a registry architecture.

6. The system as recited in claim 1, wherein the expanded software build is to include the baseline software build and disable at least one feature identified in the build configuration information, wherein when the operational state of a feature is off, the feature is disabled in the expanded build.

7. A machine implemented method for dynamically enabling features to a selected population during runtime, comprising:
responsive to identification of a user and device at runtime of an application, determining whether an installation of the application is a baseline population or a non-baseline population, based at least on the user and device identification;
retrieving configuration information from a data store based on the determining;
enabling a baseline of features for the application when the population is the baseline population; and
enabling a baseline of features and a set of selected optional features for the application when the population is the non-baseline population, wherein the selected optional features are identified in the configuration information.

8. The machine implemented method, as recited in claim 7, further comprising:
disabling at least one feature identified in the configuration information, wherein when an operational state of the at least one feature is off, then the at least one feature is disabled during runtime.

9. The machine implemented method as recited in claims 7, wherein the identification of a user and device is performed either on the device or on a server communicatively coupled to the device.

10. The method as recited in claim 7, wherein the data store comprises a system registry emulation data store when the device does not utilize a registry architecture.

11. The method as recited in claim 7, wherein determining whether the installation is a baseline population or a non-baseline population, further comprises:
applying a ratio for base population and non-baseline population to an audience; and
associating at least one of the user or device with the baseline population or the non-baseline population, based in part on the ratio.

12. The method as recited in claim 7, wherein enabling the set of selected optional features includes:
retrieving feature information from the configuration information using an application program interface within the application to enable each of the optional features in the set of selected optional features, at runtime.

13. The method as recited in claim 7, further comprising:
providing feedback on usage of the application, wherein the feedback identifies the determined population, and a qualitative measure associated with the application.

14. A machine readable storage medium having instructions stored thereon, the instructions when executed on a machine cause the machine to:
identify a user and device at runtime of an application;
determine whether an installation of the application is a baseline population or a non-baseline population, based at least on the user and device;
retrieve configuration information from a data store based on the determining; and
enable a baseline of features for the application when the population is the baseline population; and
enable a baseline of features and a set of selected optional features for the application when the population is the non-baseline population, wherein the selected optional features are identified in the configuration information.

15. The machine readable storage medium, as recited in claim 14, further comprising instructions to:
disable at least one feature identified in the configuration information, wherein when an operational state of the at least one feature is off, then the at least one feature is disabled during runtime.

16. The medium as recited in claim 14, wherein the data store comprises a system registry on the device or a system registry emulation data store when the device does not utilize a registry architecture.

17. The medium as recited in claim 14, further comprising instructions to:
receive the configuration information over a network from a configuration system; and
store the configuration information in the data store in a format accessible by an application program interface call in code in the application, the code associated with an optional feature, wherein the configuration information identifies an operational state for the optional feature.

18. The medium as recited in claim 14, wherein determining whether the installation is a baseline population or a non-baseline population, further comprises instructions to:
apply a ratio for base population and non-baseline population to an audience; and
associate at least one of the user or device with the baseline population or the non-baseline population, based in part on the ratio.

19. The medium as recited in claim 14, wherein enabling the set of selected optional features includes instructions to:
retrieve feature information from the configuration information using an application program interface within the application to enable each of the optional features in the set of selected optional features, at runtime.

20. The medium as recited in claim 14, further comprising instructions to:
provide feedback on usage of the application, wherein the feedback identifies the determined population, and a qualitative measure associated with the application.
